(19) United States
(12) Patent Application Publication
(10) Pub. No.: US 2026/0184978 A1
(43) Pub. Date: Jul. 2, 2026

(54) Flame-retardant and corrosion-resistant high thermal conductivity composition and an immersed cooling energy storage system using the same

(71) Applicants: DIGI-TRIUMPH TECHNOLOGY INC., Taipei City (TW); TAIWAN MAXWAVE CO., LTD., Taipei City (TW)

(72) Inventors: TAI ANN LEE, Taipei City (TW); FON-SHIN YU, Taipei City (TW)

(21) Appl. No.: 19/230,751

(22) Filed: Jun. 6, 2025

(30) Foreign Application Priority Data
Dec. 31, 2024 (TW) 113151726

(51) Int. Cl. C09K 5/04; H01M 10/613; H01M 10/6567; H01M 10/659

(52) U.S. Cl. CPC C09K 5/048; H01M 10/613; H01M 10/6567; H01M 10/659

(57) ABSTRACT

The present invention provides a flame-retardant and corrosion-resistant high thermal conductivity composition. The flame-retardant and corrosion-resistant high thermal conductivity composition includes a fluoroketone, a perfluoroalkene compound and a perfluoroalkene trimer. The present invention also provides a single-phase immersed cooling energy storage system and a two-phase immersed cooling energy storage system. The flame-retardant, corrosion-resistant and high thermal conductivity composition can be set to meet various application scenarios as required.

### FIELD OF THE INVENTION

The present invention relates to a flame-retardant, corrosion-resistant and highly thermally conductive composition and an immersion-type cooling energy storage system using the same, and especially to a flame-retardant, corrosion-resistant and highly thermally conductive composition that can be flexibly adjusted to meet the safety requirements of various energy storage in various application scenarios and an immersion-type cooling energy storage system using the flame-retardant, corrosion-resistant and highly thermally conductive composition.

### BACKGROUND OF THE INVENTION

The climate patterns under the present extreme climate have a significant impact on renewable energy generation. How to ensure the stability of the power grid is crucial to each industry and people's daily life. This is also the concept of the power grid resilience plan that many governments around the world currently endeavor to promote.

In prior art, rechargeable battery energy storage systems have become an indispensable part of power systems due to their characteristics of fast response, continuous output and flexible adjustment. Rechargeable battery energy storage systems can achieve the effects of rapid frequency stabilization, voltage maintenance and effective load transfer management. Rechargeable battery energy storage systems can even quickly adjust power supply in the emergencies, load fluctuations or other challenges, so as to maintain power grid resilience and achieve the benefits of the grid resilience plan described above.

Furthermore, the energy storage system has multiple application scenarios and has different design purposes according to its locations and functions. For example, the power generation terminal can be coupled with solar and wind power generation systems to store the electricity generated by renewable energy sources during daytime and to release the electricity to meet the power demand during peak hours at night. In view of power grid, the main goal of the energy storage system is to stabilize the grid frequency and alleviate the impact of renewable energy on the grid, and it also has the function of electric energy transfer. On the user's terminal, no matter it is for industrial plants, commercial shops or residential use, the electricity consumption can be dispatched and controlled according to the signed contracts. Common functions of energy storage systems include: suppressing peak power consumption; offsetting over-consumption loads to avoid over-consumption; increasing off-peak loads, obtaining time-based electricity price differences by using off-peak electricity prices; efficiently managing electricity bills; shaving transferable load peaks and reducing contract capacity; adding virtual feeder and virtual power plants to allow for additional over-consumption during the same period without over-consumption; providing micro-grids during power outages; and, when the power grid is unstable, forming an autonomous independent power grid and a stable power grid.

However, the high energy density of rechargeable batteries used in various electric vehicles in the present time also has potential safety risks. For example, taking the rechargeable battery as an example, its material is a highly active chemical material, so that once the rechargeable battery energy storage system has thermal runaway or other failure conditions, it is very easy to cause combustion, fire, and even explosion in severe cases.

Furthermore, as for preventing thermal runaway of the battery module, the principle is to perform external heat dissipation or flame retardancy to prevent the battery from burning or exploding when it overheats. Take flame retardancy in the research field of avoiding thermal runaway as an example, no matter the flame retardancy is gas flame retardancy, liquid flame retardancy, solid flame retardancy, or phase change flame retardancy, the required equipment and materials are relatively expensive and therefore not cost-effective. Furthermore, taking the research field of rapid heat dissipation as an example, the disadvantages of the forced air cooling system are that the cooling effect is slow and the energy consumption is high; the liquid cooling system is limited by the pipeline design and cannot cool the high-temperature part of the rechargeable battery in time.

Furthermore, in the research field of immersion-type flame retardancy, once the pure water is contaminated, there is a risk of being electrically conductive and it would result in mechanical damage; while oily-immersion-type flame retardancy has a technical problem that the oily material is easy to be melted with the material on the circuit board. Although Fluorocarbon-based immersion-type flame retardant liquids do not have the above technical problems, the information of the related research and development is very rare.

Furthermore, in the process of developing renewable energy and distributed power reform in various countries, no matter for the power generation side, the transmission side, and distribution side, or the user side, it is required to use a certain proportion of energy storage to serve as necessary purposes such as grid stability, output regulation, and backup scheduling. In particular, in the densely populated region of our country, as the proportion of renewable energy generation increases and the electric vehicles have become more popular, the installation location of energy storage systems will need to be closer to the working and living places of ordinary people. Therefore, how to build a stable, reliable, high-energy-density, fast-response and safe battery energy storage system is a topic that the green energy industry must face very seriously.

On the other hand, for the energy storage systems that are mainly based on rechargeable batteries and used in electric vehicles, such as electric vehicles, electric motorcycles, electric buses, electric boats, drones, electric robots, etc., once a thermal runaway accident occurs, it will cause irreparable serious casualties and property losses to the drivers or passengers on the above vehicles or in the surrounding environment.

On the other hand, for electronic devices that require high-energy precision computation, such as energy storage systems in various AI data centers today, due to the particularity of electronic devices that require high-energy precision computation, such as AI data centers, because the casings of the above server and other devices or the internal precision components are very likely to be in direct or indirect contact with the coolant for a long time, it is not allowed to use the cooling liquid that will corrode the casings of the server and other devices or the internal precision components such as processors in the research fields of avoiding thermal runaway. In addition, the energy storage system can provide long-term backup and power scheduling functions, and can be combined with the micro-grid system to build an AI computing center using all-green electricity. Since AI data centers are expensive to build, it is imperative that the energy storage equipment installed therein should meet high security requirements. Furthermore, in order to solve the problem of conventional coolant corroding the device, it is necessary to additionally install various filters to avoid the device corrosion problem caused by long-term immersion in coolant. Therefore, there is an urgent need for a coolant that can continuously control temperature, be flame-retardant, and extend battery life, as well as a cooling system corresponding to this kind of coolant.

Therefore, in order to overcome the technical problems described above, the present invention has been provided.

### SUMMARY OF THE INVENTION

Applicant has accumulated many years of experience and expertise in the application of energy storage systems, and has used the characteristics of fluorocarbon-based chemical materials to improve the safety of existing battery and other energy storage systems and various electronic systems, allowing all industrial and household users who use energy storage systems and electronic systems to enjoy the convenience and energy-saving effects brought by the above systems while avoid extremely serious property damage and loss of life once the existing safety mechanisms fail. At the same time, the present invention also solves the problem of shortened service life of battery modules and electronic systems caused by uneven heat dissipation or poor thermal conductivity within the battery modules and arrays in the above systems, and can also effectively solve the problems of the various hidden dangers caused by thermal runaway in the above systems.

In order to achieve above objects, the present invention provides a flame-retardant and corrosion-resistant high thermal conductive composition for immersion-type flame retardancy, comprising a fluoroketone, a perfluoroolefin compound and a perfluoroolefin trimer; wherein the weight percentage of the sum of the fluoroketone and the perfluoroolefin compound is greater than the weight percentage of the perfluoroolefin trimer; wherein the fluoroketone and the perfluoroolefin compound are compounds having a molecular formula of C₆F₁₂O.

In implementation, the content of the fluoroketone and the perfluoroolefin is 80 wt % to 90 wt % by weight of the flame-retardant, corrosion-resistant and highly thermally conductive composition; and the perfluoroolefin trimer is 10 wt % to 20 wt % by weight of the flame-retardant, corrosion-resistant and highly thermally conductive composition.

In implementation, the fluoroketone includes 1,1,1,2,2,4,5,5,5-nonafluoro-4-(trifluoromethyl)-3-pentanone, and the perfluoroalkane compound includes 1,1,1,2,3,4,5,5,5-nonafluoro-4-(trifluoromethyl)pent-2-ene.

In implementation, the perfluoroolefin trimer includes a trimer of 1,1,2,3,3,3-hexafluoro-1-propylene (1-Propene, 1,1,2,3,3,3-hexafluoro).

In implementation, the fluoroketone is less than 70 wt % by weight of the flame-retardant, corrosion-resistant and highly thermally conductive composition.

In implementation, the perfluoroolefin trimer includes 2,3-epoxyperfluoro-3-isopropyl-4-methylpentane.

In implementation, the fluoroketone is 60 wt % by weight of the flame-retardant, corrosion-resistant and highly thermally conductive composition, the perfluoroolefin compound is 25 wt % by weight of the flame-retardant, corrosion-resistant and highly thermally conductive composition, and the perfluoroolefin trimer is 15 wt % by weight of the flame-retardant, corrosion-resistant and highly thermally conductive composition, such that the boiling point of the flame-retardant, corrosion-resistant and highly thermally conductive composition is between 55° C. and 60° C.

The present invention further provides a single-phase immersion-type cooling energy storage system, comprising: a heat exchange buffer element, for storing heat exchange material; a heat exchange device, connected with the heat exchange buffer element for adjusting the heat exchange of the heat exchange buffer element; an immersion tank, defining an internal cavity for accommodating an electronic device or an energy storage module, wherein the internal cavity is partially or completely filled with the flame-retardant, corrosion-resistant and highly thermally conductive composition for immersion-type flame retardancy; and a first pipeline structure, arranged between the heat exchange buffer element and the immersion tank to allow the flame-retardant, corrosion-resistant and highly thermally conductive composition to be circulated between the heat exchange buffer element and the immersion tank, so as to adjust the temperature of the flame-retardant, corrosion-resistant and highly thermally conductive composition.

In implementation, the single-phase immersion-type cooling energy storage system further comprises a first control unit, being electrically connected with the energy storage module to adjust the voltage and current of the energy storage module.

In implementation, the single-phase immersion-type cooling energy storage system further comprises a second control unit, being connected with the first pipeline structure to adjust the flow of the heat exchange material controlled by a pump provided on the heat exchange buffer element.

In implementation, the single-phase immersion-type cooling energy storage system further comprises a second pipeline structure, being provided between the heat exchange buffer element and the heat exchange device to allow the heat exchange material to be circulated between the heat exchange buffer element and the heat exchange device.

The present invention further provides a two-phase immersion-type cooling energy storage system, comprising: a heat exchange buffer element, for storing heat exchange material; a heat exchange device, connected with the heat exchange buffer element for regulating the circulation temperature of the heat exchange buffer element; and an immersion tank, defining an internal cavity for accommodating an energy storage module, wherein the internal cavity is connected with the heat exchange buffer element, and the internal cavity is partially or completely filled with the flame-retardant, corrosion-resistant and highly thermally conductive composition for immersion-type flame retardancy; wherein the temperature of the flame-retardant, corrosion-resistant and highly thermally conductive composition is adjusted by transferring the heat exchange material back and forth between the heat exchange buffer element and the heat exchange device.

In implementation, the internal cavity is fluidically connected with the interior of the heat exchange buffer element.

In implementation, the heat exchange buffer element includes a condensation unit, which is in contact with only the gaseous part of the flame-retardant, corrosion-resistant and highly thermally conductive composition.

In implementation, the heat exchange buffer element, the heat exchange device, and the immersion tank are contained in a body; the heat exchange device includes an evaporator, a box and a pump, and the evaporator is connected with one end of the heat exchange buffer element and the box, and the box is connected with the pump, and the pump is connected with the other end of the heat exchange buffer element; the heat exchange material in the box is driven by the pump to be circulated between the heat exchange buffer element and the evaporator to adjust the temperature of the flame-retardant, corrosion-resistant and highly thermally conductive composition.

In implementation, the evaporator has an external surface provided with a heat dissipation fin, and the heat dissipation fin is provided with a fan.

For further understanding the characteristics and effects of the present invention, some preferred embodiments referred to drawings are in detail described as follows.

### BRIEF DESCRIPTION OF DRAWINGS

FIG. 1 is a schematic structural diagram of a single-phase immersion-type cooling energy storage system according to an embodiment of the present invention.

FIG. 2 is a schematic structural diagram of a single-phase immersion-type cooling energy storage system according to another embodiment of the present invention.

FIG. 3 is a schematic structural diagram of a two-phase immersion-type cooling energy storage system according to another embodiment of the present invention.

FIGS. 4A to 4F are three-dimensional schematic diagrams of a two-phase immersion-type cooling energy storage system according to another embodiment of the present invention.

### DETAILED DESCRIPTIONS OF PREFERRED EMBODIMENTS

The present invention refers to various content ranges to describe the content of the compositions of the present invention. Unless otherwise indicated to the contrary in the context, all ranges set forth herein should be interpreted as being inclusive of their endpoints. Furthermore, in certain embodiments, all numerical ranges should be construed to include intermediate values unless the context indicates otherwise. In some embodiments, the term “about” herein refers to ±10% of the stated value. In some embodiments, the term “about” herein refers to ±5% of the stated value. In some embodiments, the term “about” herein refers to ±2% of the stated value. In some embodiments, the term “about” herein refers to ±1% of the stated value. For example, “about 10 wt %” refers to a numerical range that is 10%, 5%, 2%, or 1% less or greater than 10 wt %.

In the examples of the present invention, the weight percentage of the sum of the fluoroketone and the perfluoroolefin compound is greater than the weight percentage of the perfluoroolefin trimer, such that the boiling point of the flame-retardant, corrosion-resistant and highly thermally conductive composition can be set in line with various application scenarios. In certain embodiments of the present invention, please refer to the following Tables 1 to 4, based on the actual requirements of cooling and flame retardancy of energy storage devices, the boiling point of the flame-retardant, corrosion-resistant and highly thermally conductive composition can be adjusted to meet various application scenarios according to the above or below formula ratios. For example, the application scenario is between about 45° C. and about 80° C., so as to meet the temperature control requirements for different types of energy storage devices, which are all within the scope of the present invention. Furthermore, in other embodiments, the fluoroketone and perfluoroalkane compounds of the present invention are compounds having the molecular formula C₆F₁₂O, such as but not limited to: 1,1,1,3,3,4,5,5,5-nonafluoro-4-(trifluoromethyl)pentan-2-one, 1,1,1,3,4,4,5,5,5-nonafluoro-3-(trifluoromethyl)pentan-2-one, 1,1,1,2,4,4,5,5,5-nonafluoro-2-(trifluoromethyl)pentan-3-one, dodecafluorohexan-2-one and dodecafluorohexan-3-one, 1,1,1,3,4,4,4-heptafluoro, 3-bis(trifluoromethyl)butan-2-one.

The flame-retardant, corrosion-resistant and high thermal conductivity composition provided by the present invention, in addition to the corrosion resistant function, also has the function of immersion cooling and immersion flame retardancy. As mentioned above, the flame-retardant, corrosion-resistant and highly thermally conductive composition of the present invention comprises fluoroketone, perfluoroolefin compound and perfluoroolefin trimer. Fluorocarbons are compounds with carbon-fluorine bonds. Compounds with CF bonds have better stability, volatility and hydrophobicity.

Furthermore, in one embodiment of the present invention, the fluoroketone, perfluoroolefin compound and perfluoroolefin trimer used are shown in Table 1 below. In one embodiment, the fluoroketone of the present invention is 1,1,1,2,2,4,5,5,5-nonafluoro-4-(trifluoromethyl)-3-pentanone and the perfluoroalkane compound is 1,1,1,2,3,4,5,5,5-nonafluoro-4-(trifluoromethyl)pent-2-ene. In another embodiment of the present invention, the perfluoroolefin trimer is formed by oxidizing the double bond rings of the trimer of 1-propylene, 1,1,2,3,3,3-hexafluoro-. For example, it is 2,3-Epoxyperfluoro-3-isopropyl-4-methylpentane. In another embodiment of the present invention, the perfluoroalkane trimer is not substituted by 0 or N as substituents. In another embodiment of the present invention, the perfluoroolefin trimer is a trimer of 1,1,2,3,3,3-hexafluoro-1-propylene (1-Propene, 1,1,2,3,3,3-hexafluoro).

TABLE 1

| | Fluorone | | Perfluoroolefin compounds | | Perfluoroolefin trimer | |
|---|---|---|---|---|---|---|
| Compound | Perfluoro- | | Perfluoro, | | 1-Propene, | |
| Name | Methyl- | | 1,1,1,2,3,4,5,5,5-nonafluoro-4- | | 1,1,2,3,3,3-hexafluoro-, trimer | |
| | Pentanone | | (trifluoromethyl)pent-2-ene | | | |
| | 1,1,1,2,2,4,5,5,5- | | | | | |
| | nonafluoro-4- | | | | | |
| | (trifluoromethyl)-3- | | | | | |
| | pentanone | | | | | |
| CAS Name | 756-13-8 | | 2070-70-4 | | 6792-31-0 | |
| Boiling Point | 49.2° | C. | 47° | C. | 110° | C. |
| Standard | 40.4 | kPa | 36 | kPa | 3.5 | kPa |
| osmotic | | | | | | |
| pressure | | | | | | |
| Liquid | 1.6 | g/cm³ | 1.601 | g/cm³ | 1.83 | g/cm³ |
| Density | | | | | | |
| Expansion | 0.0018 | K⁻¹ | 0.0019 | K⁻¹ | 0.0014 | K⁻¹ |
| coefficient | | | | | | |
| Heat of | 88 | J/g | 96.19 | J/g | 82.05 | J/g |
| vaporization | | | | | | |
| Thermal | 0.059 | W/mK | 0.061 | W/mK | 0.089 | W/mK |
| conductivity | | | | | | |
| Kinematic | 0.524 | cSt | 0.3562 | cSt | 1.353 | cSt |
| viscosity | | | | | | |
| Specific heat | 1.013 | | 1.2787 | | 1.014 | |
| (25° C.) | | | | | | |
| Dielectric | 110 | | 71.1 | | 39 | |
| strength (test | | | | | | |
| distance: | | | | | | |
| 2.5 mm) | | | | | | |
| Dielectric | 1.8 | | 1.97 | | 1.79 | |
| constant | | | | | | |
| (1 MHz) | | | | | | |
| Resistivity | 1*10¹² | Ω · mm | 3.07*10¹⁵ | Ω · mm | 2.484*10¹⁵ | Ω · mm |
| Molecular | 316.04 | gm | 300.05 | gm | 450.07 | gm |

weight

In another embodiment of the present invention, the fluoroketone is less than 70 wt % by weight of the flame-retardant, corrosion-resistant and highly thermally conductive composition. In another embodiment, the fluoroketone is 60 wt % by weight of the flame-retardant, corrosion-resistant and highly thermally conductive composition, the perfluoroolefin compound is 25 wt % by weight of the flame-retardant, corrosion-resistant and highly thermally conductive composition, and the perfluoroolefin trimer is 15 wt % by weight of the flame-retardant, corrosion-resistant and highly thermally conductive composition, such that the boiling point setting of the flame-retardant, corrosion-resistant and highly thermally conductive composition is suitable for various application scenarios, for example, an application scenario between about 55° C. and about 65° C.

In another embodiment of the present invention, the content of the fluoroketone and the perfluoroolefin is 80 wt % to 90 wt % by weight of the flame-retardant, corrosion-resistant and highly thermally conductive composition, and the perfluoroolefin trimer is 10 wt % to 20 wt % by weight of the flame-retardant, corrosion-resistant and highly thermally conductive composition. Please refer to Tables 1 and 2 above. In Examples 1 to 6 of the present invention, the content of the fluoroketone and the perfluoroolefin is 80 wt % to 90 wt % (80 wt %, 85 wt %, 90 wt %) by weight of the flame-retardant, corrosion-resistant and highly thermally conductive composition; and the perfluoroolefin trimer is 10 wt % to 20 wt % (10 wt %, 15 wt %, 16 wt %, 20 wt %) by weight of the flame-retardant, corrosion-resistant and highly thermally conductive composition. Please continue to refer to Tables 1 to 4 above. The flame-retardant, corrosion-resistant and highly thermally conductive compositions corresponding to Examples 1 to 9 all exhibit a stable range of physical and chemical properties, such as a stable boiling point, saturated vapor pressure at 25° C., heat of vaporization, specific heat capacity and thermal conductivity. In other embodiments of the present invention, the weight percentage ratio of the fluoroketone, the perfluoroolefin compound and the perfluoroolefin trimer can also be adjusted as required. For example, the boiling point of the flame-retardant, corrosion-resistant and highly thermally conductive composition can be adjusted to be about 30° C. to about 40° C., about 40° C. to about 50° C., about 50° C. to about 60° C., about 60° C. to about 70° C., about 70° C. to about 80° C., about 80° C. to about 90° C., about 90° C. to about 100° C., about 100° C. to about 110° C., and a combination of at least two of any of the above endpoints. For example, 40° C. to 100° C., 40° C. to 90° C., etc., are all within the scope of the present invention.

TABLE 2

| | Example 1 | Example 2 | Example 3 |
|---|---|---|---|
| Fluorone | 40 wt % | 50 wt % | 60 wt % |
| Perfluoroolefin | 40 wt % | 30 wt % | 25 wt % |
| compounds | | | |
| Perfluoroolefin trimer | 20 wt % | 20 wt % | 15 wt % |
| Boiling Point | 60.5 | 60.7 | 57.8 |
| Melting point | −111.8 | −110.9 | −110.4 |
| Saturated vapor pressure | 31.3 | 31.7 | 33.8 |
| (25° C.) | | | |
| Liquid Density | 1.6 | 1.6 | 1.6 |
| Expansion coefficient | 0.00176 | 0.00175 | 0.00177 |
| Heat of vaporization | 90.09 | 89.27 | 89.16 |
| Thermal conductivity | 0.068 | 0.067 | 0.065 |
| Kinematic viscosity | 0.6227 | 0.6395 | 0.6064 |
| Specific heat (25° C.) | 1.119 | 1.093 | 1.080 |
| Dielectric strength | 80.2 | 84.1 | 89.6 |
| Dielectric constant | 1.87 | 1.85 | 1.84 |
| (1 KHz) | | | |
| Resistivity (25° C.) Ω · | 4.017E−13 | 5.01E−13 | 6.01E−13 |
| Mm | | | |
| Molecular weight | 336.45 | 338.05 | 332.15 |

TABLE 3

| | Example 4 | Example 5 | Example 6 |
|---|---|---|---|
| Fluorone | 70 | 75 | 85 |
| Perfluoroolefin | 20 | 10 | 5 |
| compounds | | | |
| Perfluoroolefin trimer | 10 | 16 | 10 |
| Boiling Point | 60.3 | 60.7 | 60.2 |
| Melting point | −111.5 | −112.6 | −111.6 |
| Saturated vapor pressure | 31.6 | 32.0 | 31.5 |
| (25° C.) | | | |
| Liquid Density | 1.6 | 1.7 | 1.6 |
| Expansion coefficient | 0.00176 | 0.00178 | 0.00176 |
| Heat of vaporization | 89.83 | 90.76 | 89.95 |
| Thermal conductivity | 0.067 | 0.068 | 0.068 |
| Kinematic viscosity | 0.6244 | 0.6280 | 0.6219 |
| Specific heat (25° C.) | 1.110 | 1.122 | 1.114 |
| Dielectric strength | 82.0 | 82.9 | 81.4 |
| Dielectric constant | 1.86 | 1.88 | 1.86 |
| (1 KHz) | | | |
| Resistivity (25° C.) Ω · | 7.01E−13 | 7.51E−13 | 8.50E−13 |
| Mm | | | |
| Molecular weight | 336.34 | 339.29 | 336.10 |

TABLE 4

| | Example 7 | Example 8 | Example 9 |
|---|---|---|---|
| Fluorone | 30 | 25 | 20 |
| Perfluoroolefin | 30 | 35 | 32 |
| compounds | | | |
| Perfluoroolefin trimer | 40 | 40 | 48 |
| Boiling Point | 72.9 | 72.8 | 77.7 |
| Melting point | −111.1 | −111.6 | −111.4 |
| Saturated vapor pressure | 24.3 | 24.1 | 21.3 |
| (25° C.) | | | |
| Liquid Density | 1.7 | 1.7 | 1.7 |
| Expansion coefficient | 0.00167 | 0.00168 | 0.00164 |
| Heat of vaporization | 88.08 | 88.49 | 87.76 |
| Thermal conductivity | 0.073 | 0.073 | 0.076 |
| Kinematic viscosity | 0.8053 | 0.7969 | 0.8682 |
| Specific heat (25° C.) | 1.093 | 1.106 | 1.099 |
| Dielectric strength | 69.9 | 68.0 | 63.5 |
| Dielectric constant | 1.85 | 1.86 | 1.85 |
| (1 KHz) | | | |
| Resistivity (25° C.) Ω · | 8.50E−14 | 8.50E−15 | 8.50E−16 |
| Mm | | | |
| Molecular weight | 364.86 | 364.06 | 375.26 |

Furthermore, Applicant has discovered that fluorocarbon-based or fluoroolefin-based compounds have stable chemical properties, a long half-life, and have water- and oil-repellent chemical properties after years of research. Furthermore, the fluorocarbon bonds in fluorocarbon or fluoroolefin compounds are chemically stable and have a large molecular weight, are hydrophobic and oleophobic, have low friction, and have good thermal conductivity, corrosion resistance, and low reactivity. Furthermore, ketone compounds themselves have good volatility and can quickly absorb a large amount of heats when the energy storage module heats up rapidly or even catches fire, thereby achieving the technical effects of rapid flame retardancy and rapid cooling. Furthermore, if the above molecular structure contains a hydroxyl functional group, this functional group provides the overall molecule with fluid chemical reactivity and photolysis reactivity. The carbon-fluorine bond is strong because of the electronegativity of fluorine, which is able to impart partial ionic character to this bond through some charges on the carbon and fluorine atoms, and in comparison with a carbon-hydrogen bond, this bond is shortened and its stability is strengthened through covalent interactions. Additionally, multiple carbon-fluorine bonds increase the strength and stability of other nearby carbon-fluorine bonds to the same carbon because the carbons in the same orientation have a higher positive charge.

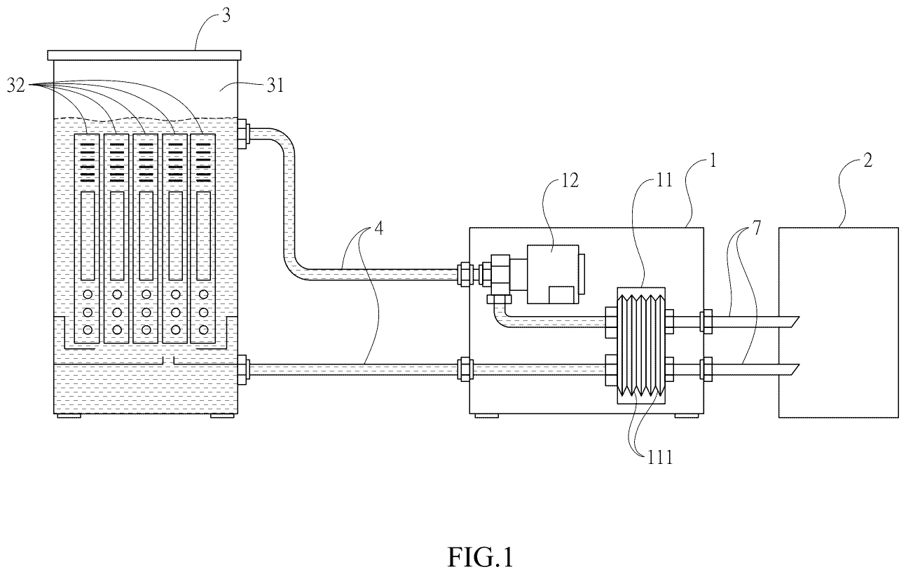

Please refer to FIG. 1, the present invention provides a single-phase immersion-type cooling energy storage system. In another embodiment, the single-phase immersion-type cooling energy storage system includes: a heat exchange buffer element 1, a heat exchange device 2, an immersion tank 3 and a first pipeline structure 4. The heat exchange buffer element 1 includes a condensation unit 11, and a cooling spiral pipeline 111 of the condensation unit 11 contains a heat exchange material. The heat exchange material can be various liquid or gaseous heat exchange materials, all of which are within the scope of the present invention. The heat exchange device 2 is connected with the heat exchange buffer element 1 for adjusting the heat exchange of the heat exchange buffer element 1. The immersion tank 3 defines an internal cavity 31, and the internal cavity 31 is for accommodating various electronic devices 32 or energy storage modules 32′. In one embodiment, the electronic device 32 of the present invention can be a variety of industrial, commercial, and home servers, hard drives, motherboards, processors, etc.; the energy storage module 32′ is an energy storage battery module or a backup power module for a variety of industrial, commercial, electric vehicles in other scenarios. Further, please continue to refer to FIG. 1, in one embodiment of the present invention, the internal cavity 31 is partially or completely filled with the flame-retardant, corrosion-resistant and highly thermally conductive composition as described in at least one of the above or below embodiments. As described in the above embodiments of the present invention, the required component ratio of the flame-retardant, corrosion-resistant and highly thermally conductive composition is determined according to the temperature control requirements and is within the scope of the present invention. Further, please continue to refer to FIG. 1. The first pipeline structure 4 is provided between the heat exchange buffer element 1 and the immersion tank 3 to allow the flame-retardant, corrosion-resistant and highly thermally conductive composition described in at least one of the above or below embodiments to be circulated between the heat exchange buffer element 1 and the immersion tank 3, thereby adjusting the temperature of the flame-retardant, corrosion-resistant and highly thermally conductive composition. By the circulation of the flame-retardant, corrosion-resistant and highly thermally conductive composition of the present invention, the temperature of the flame-retardant, corrosion-resistant and highly thermally conductive composition described in at least one of the above or below embodiments can be maintained at an optimal temperature control state.

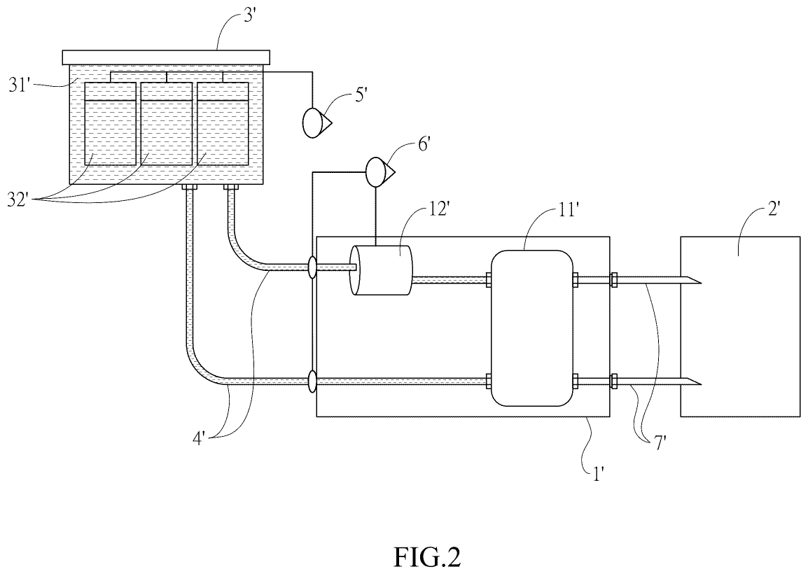

In another embodiment, please refer to FIG. 2, in addition to the above components, the single-phase immersion-type cooling energy storage system of the present invention further includes a first control unit 5′ electrically connected with the energy storage module to adjust the voltage and current of the energy storage module 32′. In another embodiment, please continue to refer to FIG. 2, the above single-phase immersion-type cooling energy storage system further includes a second control unit 6′ connected with the first pipeline structure 5′ for adjusting the flow rate and flow velocity of the flame-retardant, corrosion-resistant and highly thermally conductive composition driven by the pump 12′ connected with the first pipeline structure 5′.

Please continue to refer to FIG. 2. In another embodiment, for example, if the ambient temperature is higher in the summer or the electronic device 32 such as a server is under a high load period, the internal cavity 31′ defined by the immersion tank 3′ of the present invention accommodates various electronic devices 32 or energy storage modules 32′, which would have high heat generation, causing the temperature of the immersion tank 3′ to rise rapidly. This situation will cause the overall electronic system corresponding to the electronic device 32 or the energy storage module 32′ to be in danger of thermal runaway. Therefore, the first control unit 5′ of the present invention is used to adjust the voltage and current of the energy storage module 32′ to balance the power of the corresponding overall system, and the second control unit 6′ is used to adjust the flow rate and flow velocity of the pump 12′ connected with the first pipeline structure 4′. For example, the power delivered by the pump 12′ is increased, thereby increasing the circulation flow rate of the flame-retardant, corrosion-resistant and highly thermally conductive composition between the heat exchange buffer element 1′ and the immersion tank 3′, such that the heat exchange efficiency of the flame-retardant, corrosion-resistant and highly thermally conductive composition of the present invention is further improved; or, the cross-sectional area, for example, the pipe diameter, of the first pipeline structure 4′ is adjusted by the second control unit 6′, the above technical effect of improving the heat exchange efficiency can also be achieved.

In another embodiment, please continue to refer to FIGS. 1 and 2. The single-phase immersion-type cooling energy storage system further includes second pipeline structures 7 and 7′, and the second pipeline structures 7 and 7′ are respectively arranged between the heat exchange buffer elements 1, 1′ and the heat exchange devices 2, 2′, so as to allow the heat exchange material to be circulated between the heat exchange buffer element 1 and the heat exchange device 2. In addition, in certain embodiments of the present invention, the heat exchange buffer element 1 is further provided with a box structure (not shown), and the box structure is connected with the second pipeline structure 7 for storing the heat exchange material.

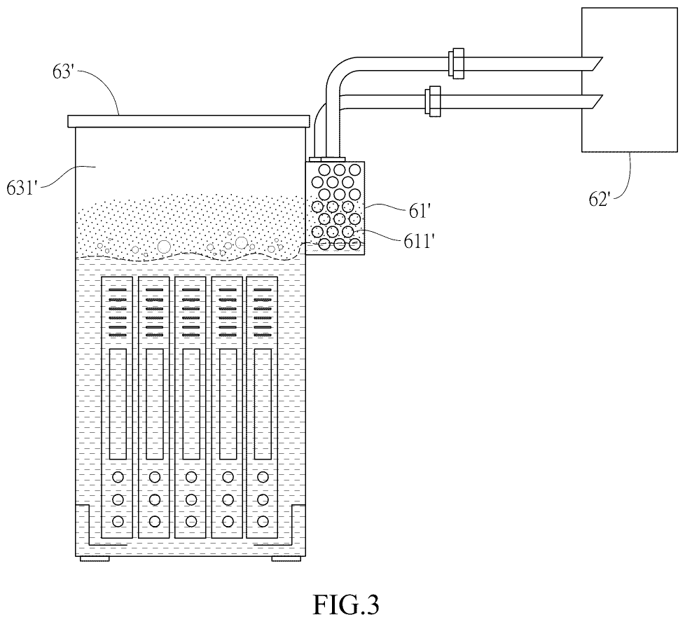

In another embodiment, please refer to the embodiment of FIG. 3. In this embodiment, the present invention further provides a two-phase immersion-type cooling energy storage system, which includes: a heat exchange buffer element 61′, a heat exchange device 62′ and an immersion tank 63′. The heat exchange buffer element 61′ stores heat exchange material and is provided with a heat exchange structure 611′. The heat exchange device 62′ is connected with the heat exchange buffer element 61′ to perform circulation temperature regulation on the heat exchange buffer element 61′. The immersion tank 63′ defines an internal cavity 631′ for accommodating an energy storage module or an electronic device, and the internal cavity 631′ is connected with the heat exchange buffer element 61′. The internal cavity 631′ is partially or completely filled with the flame-retardant, corrosion-resistant and highly thermally conductive composition as described in any of the above embodiments, such that the temperature of the flame-retardant, corrosion-resistant and highly thermally conductive composition is adjusted by transferring the heat exchange material back and forth between the heat exchange buffer element 61′ and the heat exchange device 62′. In this embodiment, the internal cavity 631′ is fluidly connected with the interior of the heat exchange buffer element 61′, and the flame-retardant, corrosion-resistant and high thermal conductivity composition is in contact with the condenser 611′ provided in the heat exchange buffer element 61′. Furthermore, the gas phase and liquid phase of the flame-retardant, corrosion-resistant and high thermal conductivity composition are both in contact with the condenser 611′ provided in the heat exchange buffer element 61′. By maintaining the temperature of the flame-retardant, corrosion-resistant and highly thermally conductive composition within a specific temperature range, the flame-retardant, corrosion-resistant and highly thermally conductive composition is allowed to absorb and release heat between the two phase changes of vaporization and liquefaction, thereby cooling the energy storage device and the electronic device.

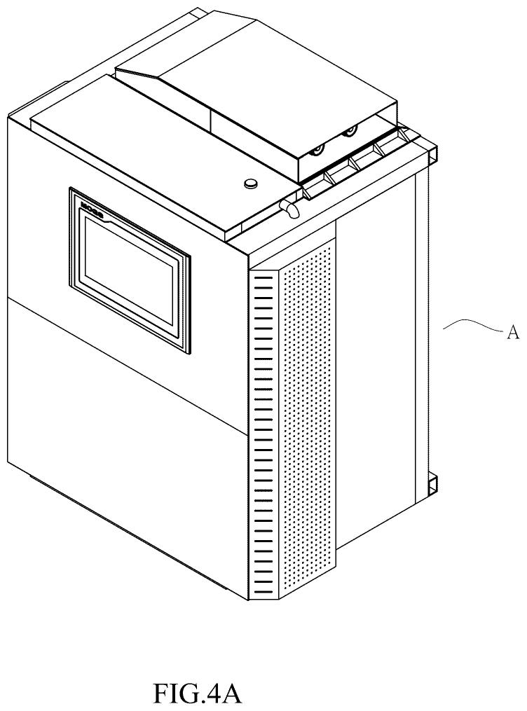

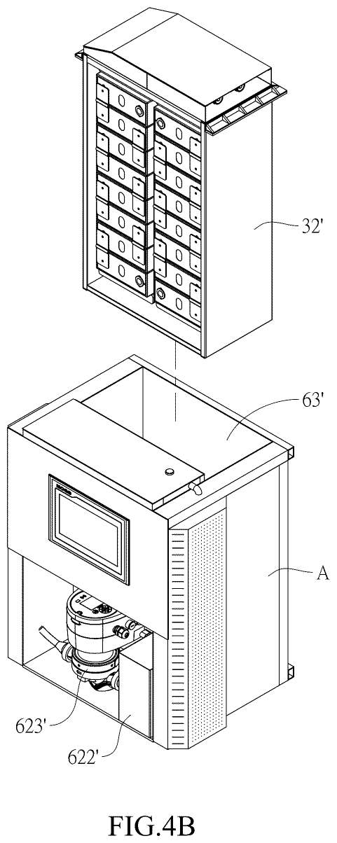

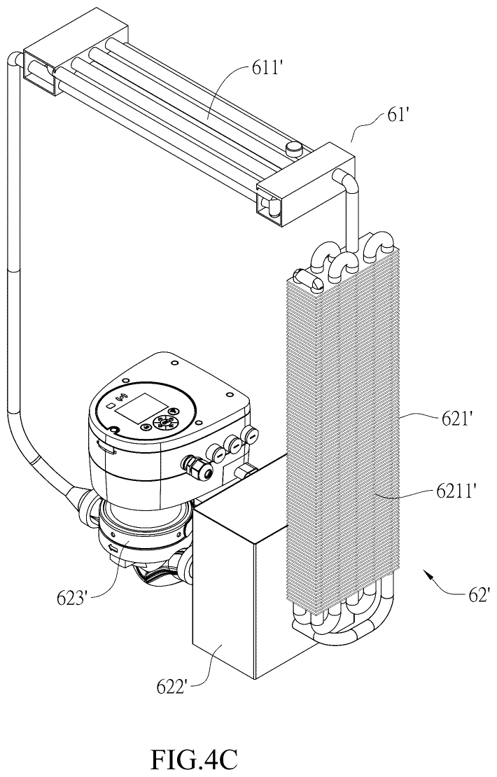

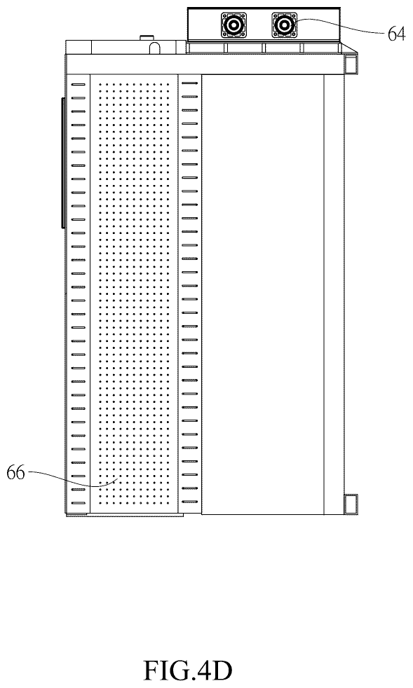

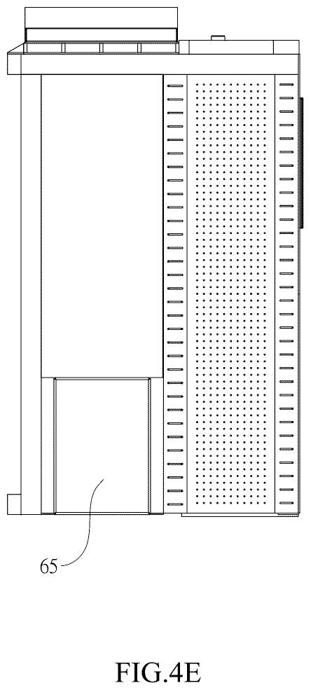

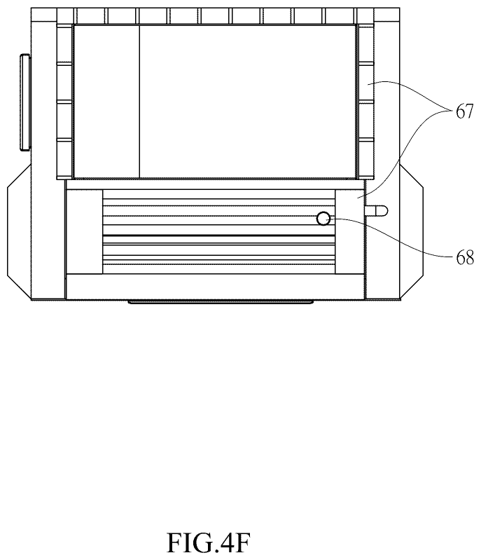

In another embodiment, please refer to the embodiments of FIGS. 4A to 4E. The present invention further provides a two-phase immersion-type cooling energy storage system A. This two-phase immersion-type cooling energy storage system A includes: a heat exchange buffer element 61′, a heat exchange device 62′ and an immersion tank 63′. The heat exchange buffer element 61′ stores heat exchange material. The heat exchange device 62′ is connected with the heat exchange buffer element 61′ to perform circulation temperature regulation on the heat exchange buffer element 61′. The immersion tank 63′ defines an internal cavity 631′ for accommodating various energy storage modules or electronic devices, and the internal cavity 631′ is provided below the heat exchange buffer element 61′. Furthermore, the heat exchange buffer element 61′ includes a condensation unit 611′, and the condensation unit 611′ is provided above the internal cavity 631′ and is in contact with only the gaseous portion of the flame-retardant, corrosion-resistant and highly thermally conductive composition; in another embodiment, the condensation unit 611′ can also be in contact with the gaseous and liquid portions of the flame-retardant, corrosion-resistant and highly thermally conductive composition. The reason why the condensation unit 611′ in the above embodiment of the present invention is in contact with only the gaseous portion of the flame-retardant, corrosion-resistant and highly thermally conductive composition is that it is only necessary to control the temperature of the flame-retardant, corrosion-resistant and highly thermally conductive composition within a relatively stable fixed range. For example, in some other embodiments of the present invention, the relatively stable fixed range is about 30° C. to about 40° C., about 40° C. to about 50° C., about 50° C. to about 60° C., about 60° C. to about 70° C., about 70° C. to about 80° C., about 80° C. to about 90° C., about 90° C. to about 100° C., about 100° C. to about 110° C., and a combination of at least two of any of the above endpoints, such as 40° C. to 100° C., 40° C. to 90° C., etc. In other words, in certain embodiments, the present invention can provide suitable physical and chemical properties to the flame-retardant, corrosion-resistant and highly thermally conductive composition, such as a suitable boiling point, saturated vapor pressure at 25° C., heat of vaporization, specific heat and thermal conductivity coefficient according to the conditions of the energy storage device itself and the temperature control requirements of the electronic device to which the energy storage device is connected. In some embodiments, the reason why the condensation unit 611′ is in contact with the gaseous and liquid parts of the flame-retardant, corrosion-resistant and highly thermally conductive composition is that, in some special or more urgent situations, the setting of contacting the two phases at the same time can achieve a faster cooling effect.

Please continue to refer to the embodiments of FIGS. 4A to 4E. The heat exchange buffer element 62′, the heat exchange device 61′ and the immersion tank 63′ are included in the main body A. The heat exchange device 61′ includes an evaporator 621′, a tank 622′ and a pump 623′, and the evaporator 621′ is connected with one end of the heat exchange buffer element 62′ and the tank 622′, and the tank 622′ is connected with the pump 623′, and the pump 623′ is connected with the other end of the heat exchange buffer element 62′. The pump 623′ is driven to allow the heat exchange material in the tank 622′ to be circulated between the heat exchange buffer element 62′ and the evaporator 621′, so as to adjust and control the temperature of the flame-retardant, corrosion-resistant and highly thermally conductive composition within the above appropriate range. Please further refer to FIG. 4B, the energy storage module 32′ of the present invention includes a plurality of battery modules connected in series, the number of which can be adjusted according to the power required by the corresponding electronic equipment, and can be conveniently withdrawn from the immersion tank 63′ for replacement, maintenance and repair.

Please refer to FIGS. 4A to 4F. The evaporator 621′ has an external surface provided with a heat dissipation fin 6211′ to enable the evaporator 621′ to dissipate heat more efficiently. In another embodiment, the heat dissipation fins 6211′ are provided with a fan (not shown) to increase the heat dissipation effect. In another embodiment, a heat dissipation plate with holes 66 is further provided on the external surface of the heat dissipation fin 6211′. Moreover, referring to FIGS. 4A to 4F, a voltage output hole 64 is provided above the main body A and on the upper side of the immersion tank 63′. The voltage output hole 64 is formed by extending the energy storage module or the electronic device for external connection with other electronic devices or other energy storage equipment. Further, please refer to FIGS. 4A to 4F, an electric panel box 65 is provided on one side of the body A for managing the power distribution to the two-phase immersion-type cooling energy storage system.

Therefore, the present invention has following advantages:
1. The immersion-type flame-retardant composition, single-phase immersion-type cooling energy storage system and two-phase immersion-type cooling energy storage system claimed in the present invention can be effectively applied to a varieties of energy storage systems corresponding to electric vehicles, AI electronic devices, various power applications, etc., thereby playing an important role in the development of global renewable energy and the pursuit of net zero carbon emissions by various countries, and making important contributions to the domestic and international market shares.
2. According to the physicochemical properties presented in the experimental examples listed in the present invention, the flame-retardant, anti-corrosion and high thermal conductive composition for immersion-type flame retardancy claimed in the present invention can adjust its composition according to actual needs, so as to achieve the technical effect of effective anti-corrosion and stable flame retardant effect by adjusting its composition in response to the cooling requirements of a varieties of energy storage devices and electronic devices.
3. The cooling system of the present invention can produce the above-mentioned technical effects for a varieties of energy storage systems, AI data centers and electric vehicle rechargeable battery energy storage systems through the control of each control unit and the composition of the coolant, thereby solving the fundamental problem of battery thermal runaway, which is the core problem of battery energy storage systems at the present time.
4. The device and composition claimed in the present invention can establish a complete energy storage immersion-type flame retardant cooling system containing an anti-rust and corrosion coolant composition, so as to achieve the expected technical effect of flame retardant performance, to fully realize the current energy storage system as an indispensable part of strengthening the power grid and green energy development, that is, the stable and safe guarantee required by energy storage equipment.
5. The physicochemical properties of the flame-retardant, corrosion-resistant and highly thermally conductive composition for immersion-type flame retardancy presented in the experimental examples listed in the present invention can be adjusted according to actual needs, so as to be effectively applied to a varieties of single-phase immersion-type cooling energy storage systems and two-phase immersion-type cooling energy storage systems developed at present time or in the future.

### SYMBOL TABLE

Heat exchange buffer element 1, 1′
Heat exchange device 2, 2′
Immersion tank 3, 3′
First pipeline structure 4, 4′
First control unit 5′
Second control unit 6′
Second pipeline structure 7
Condensation units 11, 11′
Pump 12
Internal cavity 31, 31′
Electronic device 32
Energy storage module 32′
Heat exchange buffer elements 61, 61′
Heat exchange device 62, 62′
Immersion tank 63, 63′
Voltage output port 64
Electric panel box 65
Heat dissipation plate with holes 66
Sealing plate 67
Pressure relief valve 68
Spiral pipeline 111
Heat exchange structure 611
Evaporator 621′
Tank 622′
Pump 623′
Internal cavities 631, 631′
Main body A

What is claimed is:

1. A flame-retardant and corrosion-resistant high thermal conductive composition for immersion-type flame retardancy, comprising a fluoroketone, a perfluoroolefin compound and a perfluoroolefin trimer; wherein the weight percentage of the sum of the fluoroketone and the perfluoroolefin compound is greater than the weight percentage of the perfluoroolefin trimer; wherein the fluoroketone and the perfluoroolefin compound are compounds having a molecular formula of C₆F₁₂O.

2. The flame-retardant and corrosion-resistant high thermal conductivity composition according to claim 1, wherein the content of the fluoroketone and the perfluoroolefin is 80 wt % to 90 wt % by weight of the flame-retardant, corrosion-resistant and highly thermally conductive composition; and the perfluoroolefin trimer is 10 wt % to 20 wt % by weight of the flame-retardant, corrosion-resistant and highly thermally conductive composition.

3. The flame-retardant and corrosion-resistant high thermal conductivity composition according to claim 1, wherein the fluoroketone includes 1,1,1,2,2,4,5,5,5-nonafluoro-4-(trifluoromethyl)-3-pentanone, and the perfluoroalkane compound includes 1,1,1,2,3,4,5,5,5-nonafluoro-4-(trifluoromethyl)pent-2-ene.

4. The flame-retardant and corrosion-resistant high thermal conductivity composition according to claim 1, wherein the perfluoroolefin trimer includes a trimer of 1,1,2,3,3,3-hexafluoro-1-propylene (1-Propene, 1,1,2,3,3,3-hexafluoro).

5. The flame-retardant and corrosion-resistant high thermal conductivity composition according to in claim 1, wherein the fluoroketone is less than 70 wt % by weight of the flame-retardant, corrosion-resistant and highly thermally conductive composition.

6. The flame-retardant and corrosion-resistant high thermal conductivity composition according to in claim 1, wherein the perfluoroolefin trimer includes 2,3-epoxyperfluoro-3-isopropyl-4-methylpentane.

7. The flame-retardant and corrosion-resistant high thermal conductivity composition according to claim 1, wherein the fluoroketone is 60 wt % by weight of the flame-retardant, corrosion-resistant and highly thermally conductive composition, the perfluoroolefin compound is 25 wt % by weight of the flame-retardant, corrosion-resistant and highly thermally conductive composition, and the perfluoroolefin trimer is 15 wt % by weight of the flame-retardant, corrosion-resistant and highly thermally conductive composition, such that the boiling point of the flame-retardant, corrosion-resistant and highly thermally conductive composition is between 55° C. and 60° C.

8. A single-phase immersion-type cooling energy storage system, comprising:
a heat exchange buffer element, for storing heat exchange material;
a heat exchange device, connected with the heat exchange buffer element for adjusting the heat exchange of the heat exchange buffer element;
an immersion tank, defining an internal cavity for accommodating an electronic device or an energy storage module, wherein the internal cavity is partially or completely filled with the flame-retardant, corrosion-resistant and highly thermally conductive composition for immersion-type flame retardancy as claimed in claim 1; and
a first pipeline structure, arranged between the heat exchange buffer element and the immersion tank to allow the flame-retardant, corrosion resistant and highly thermally conductive composition to be circulated between the heat exchange buffer element and the immersion tank, so as to adjust the temperature of the flame-retardant, corrosion-resistant and highly thermally conductive composition.

9. The single-phase immersion-type cooling energy storage system according to claim 8, further comprising a first control unit, being electrically connected with the energy storage module to adjust the voltage and current of the energy storage module.

10. The single-phase immersion-type cooling energy storage system according to claim 8, further comprising a second control unit, being connected with the first pipeline structure to adjust the flow of the heat exchange material controlled by a pump provided on the heat exchange buffer element.

11. The single-phase immersion-type cooling energy storage system according to claim 8, further comprising a second pipeline structure, being provided between the heat exchange buffer element and the heat exchange device to allow the heat exchange material to be circulated between the heat exchange buffer element and the heat exchange device.

12. A two-phase immersion-type cooling energy storage system, comprising:
a heat exchange buffer element, for storing heat exchange material;
a heat exchange device, connected with the heat exchange buffer element for regulating the circulation temperature of the heat exchange buffer element; and
an immersion tank, defining an internal cavity for accommodating an energy storage module, wherein the internal cavity is connected with the heat exchange buffer element, and the internal cavity is partially or completely filled with the flame-retardant, corrosion-resistant and highly thermally conductive composition for immersion-type flame retardancy as claimed in claim 1;
wherein the temperature of the flame-retardant, corrosion-resistant and highly thermally conductive composition is adjusted by transferring the heat exchange material back and forth between the heat exchange buffer element and the heat exchange device.

13. The two-phase immersion-type cooling energy storage system according to claim 12, wherein the internal cavity is fluidically connected with the interior of the heat exchange buffer element.

14. The two-phase immersion-type cooling energy storage system according to claim 12, wherein the heat exchange buffer element includes a condensation unit, which is in contact with only the gaseous part of the flame-retardant, corrosion-resistant and highly thermally conductive composition.

15. The two-phase immersion-type cooling energy storage system according to claim 12, wherein the heat exchange buffer element, the heat exchange device, and the immersion tank are contained in a body; the heat exchange device includes an evaporator, a box and a pump, and the evaporator is connected with one end of the heat exchange buffer element and the box, and the box is connected with the pump, and the pump is connected with the other end of the heat exchange buffer element; the heat exchange material in the box is driven by the pump to be circulated between the heat exchange buffer element and the evaporator to adjust the temperature of the flame-retardant, corrosion-resistant and highly thermally conductive composition.

16. The two-phase immersion-type cooling energy storage system according to claim 15, wherein the evaporator has an external surface provided with a heat dissipation fin and the heat dissipation fin is provided with a fan.
